(19) United States
(12) Patent Application Publication
(10) Pub. No.: US 2025/0139437 A1
(43) Pub. Date: May 1, 2025

(54) CHARACTERIZING ACTIVATION SPACES IN NEURAL NETWORKS USING COMPRESSED HISTOGRAMS

(71) Applicant: International Business Machines Corporation, Armonk, NY (US)

(72) Inventors: Tanya Leah Akumu, Nairobi (KE); Skyler Speakman, Nairobi (KE); Celia Cintas, Nairobi (KE); Girmaw Abebe Tadesse, Nairobi (KE); Adebayo Ayomide Oshingbesan, Nairobi (KE)

(21) Appl. No.: 18/384,314

(22) Filed: Oct. 26, 2023

(51) Int. Cl. G06N 3/082

(52) U.S. Cl. CPC G06N 3/082

(57) ABSTRACT

A computer-implemented method, according to one approach, includes: receiving a new set of test data and evaluating the test data using a pre-trained deep neural network. In response to evaluating the test data, activations are extracted from layers of the deep neural network. Compressed histograms are further used to determine p-values for the extracted activations. The p-values are evaluated and portions of the test data that are determined as being anomalous, based at least in part on the evaluation of the p-values, are retained.

### BACKGROUND

The present disclosure relates to interpreting machine learning models and to automatic identification of anomalous data.

### SUMMARY

A computer-implemented method, according to one approach, includes: receiving a new set of test data and evaluating the test data using a pre-trained deep neural network. In response to evaluating the test data, activations are extracted from layers of the deep neural network. Compressed histograms are further used to determine p-values for the extracted activations. The p-values are evaluated and portions of the test data that are determined as being anomalous, based at least in part on the evaluation of the p-values, are retained.

A computer program product, according to another approach, includes a computer readable storage medium having program instructions embodied therewith. The program instructions are readable by a processor, executable by the processor, or readable and executable by the processor, to cause the processor to: perform the foregoing method.

A system, according to yet another approach, includes: a processor as well as logic that is integrated with the processor, executable by the processor, or integrated with and executable by the processor. Moreover, the logic is configured to: perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of a method, in accordance with one approach.

FIG. 3C is a flowchart of a method, in accordance with one approach, that continues the flowchart of FIG. 3B.

FIG. 4A is a flowchart of a method, in accordance with one approach.

FIG. 4B is a flowchart of a method, in accordance with one approach that continues the flowchart of FIG. 4A.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for characterizing the activation spaces of machine learning models using compressed node-specific histograms. Implementations herein are able to use neural networks to determine (e.g., compute) p-values of observed activations without retaining already-known inputs and characterize the activation space in a task-independent manner. Trained machine learning models may thereby be used to develop an understanding of newly received data, e.g., as will be described in further detail below.

In one general approach, a computer-implemented method includes: receiving a new set of test data and evaluating the test data using a pre-trained deep neural network. In response to evaluating the test data, activations are extracted from layers of the deep neural network. Compressed histograms are further used to determine p-values for the extracted activations. The p-values are evaluated and portions of the test data that are determined as being anomalous, based at least in part on the evaluation of the p-values, are retained.

This method achieves the technical advantage that it is desirably able to characterize the activation spaces of machine learning models using compressed node-specific histograms. These compressed histograms are formed by computing p-values (probability values) of observed activations without retaining already-known inputs and characterize the activation space in a task-independent manner. The method develops model and task agnostic characterizations of the input training data. The method may thereby be applied to any model involving downstream detection tasks, e.g., object detection, image segmentation, facial recognition, image captioning, etc. This desirably reduces memory demand for downstream detection tasks, in addition to reducing runtimes, thereby achieving efficient processing even in situations involving limited resources. After node activation information is received from a neural network, the neural network is then not needed to perform the anomaly inference. Rather, a histogram representation is used which has far smaller memory usage requirements than an entire neural network has. Also, due to the compressed information the anomaly inference is able to be performed with a significantly faster determination speed as compared to other modes. Thus, the approaches described herein are scalable to vastly complicated neural network models that could have large numbers, e.g., millions, of nodes while still achieving fast anomaly inference speeds.

In some approaches, using compressed histograms to determine the p-values for the extracted activations includes, for each of the extracted activations: determining a node of the deep neural network that a given extracted activation corresponds to. The given extracted activation is preferably compared to a compressed histogram correlated with the node that the given extracted activation corresponds to. Moreover, a p-value is computed for the given extracted activation.

The characterization of new data that is performed is simplified as a result of matching nodes to activations. The anomaly inference is achievable via reduced memory usage at inference time and reduced elapsed test-time and can also provide improved privacy by implementing compressed data representations.

In some approaches, the compressed histograms are node-specific. The characterization of new data that is performed is simplified as a result of developing and implementing node-specific histograms as described above. This desirably results in reduced memory usage at inference time, reduced elapsed test-time, and improved privacy by implementing compressed data representations.

In some approaches, retaining portions of the test data that are determined as being anomalous based at least in part on the evaluation of the p-values includes: estimating a number of the extracted activations that are unexpected. The estimated number is further used to determine whether at least a portion of the test data is anomalous. In response to determining that a portion of the test data is not anomalous, the portion of the test data, and the corresponding extracted activations, are discarded.

These approaches achieve advantages of savings in computer memory usage. Node activations of neural networks can be in the order of thousands or millions, depending on the architecture of the model. The node activations are numerical datapoints so that many nodes results in many numerical datapoints to be saved. By discarding insignificant or redundant data, computer memory usage and associated costs are saved. Less memory is wasted in hosting redundant information.

Moreover, in some approaches in response to determining that another portion of the test data is anomalous, the anomalous portion of the test data, and the corresponding extracted activations are stored.

Retaining anomalous data allows for the compressed histograms described herein to characterize the activation space in deep neural networks while also retaining a minimal amount of information about the activation space. Thus, the node-specific histograms are able to learn the p-value representations of the activations of nodes in the intermediate layers of a neural network. This also reduces exposure to external attacks and privacy issues by creating a compressed (e.g., simplified) representation of the experienced activations and the data that caused the activations.

In some approaches, the compressed histograms are produced via: evaluating training data using the deep neural network, and extracting training activations from layers of the deep neural network based at least in part on the evaluation. The extracted training activations are further used to generate the compressed histograms, which are stored.

With these approaches, representations of a neural network and/or an effect of a neural network to input data are created which are usable for anomaly detection with large savings in computer memory usage and associated costs. The trained neural network itself is not needed to compute the anomaly detection and instead the histogram representations are used based on node activation information received from the neural network.

Moreover, in some approaches using the extracted training activations to generate the compressed histograms includes: for each node of the deep neural network that corresponds to a subset of the extracted training activations, using the subset of the extracted training activations to create one of the compressed histograms.

Approaches with these features are desirably able to characterize the representations of deep learning models in order to facilitate downstream detection tasks. Moreover, this characterization is model-agnostic, and therefore can be applied to any desired deep learning framework efficiently. The characterization is also task-agnostic and can be applied to various downstream tasks, e.g., such as fake image detection, adversarial attack detection in audio systems, etc. Moreover, by retraining the deep neural networks using retained portions of the test data that are determined as being anomalous, the deep neural networks continue to detect patterns in use data and improve operational efficiency over time.

In some approaches, the using the extracted training activations to generate the compressed histograms includes sorting a respective training activation into a respective bin of the compressed histograms based on a numerical value of the respective training activation.

In this manner, inner space of a neural network is represented via a histogram which takes much less memory computer storage than an actual neural network takes.

In some approaches, a number of bins of a respective compressed histogram of the compressed histograms is determined based on a maximum of an output of a Freedman Diaconis estimator and an output of a Sturges estimator for the training activations.

In this manner, an improved histogram is generated so that the node activation data that is used via a representation of the ML inner space facilitates improved predictions of a sample being anomalous.

With some additional approaches, the determination of anomalous data portions is implemented via non-parametric scan statistics.

In this manner, p-values from node activations and obtained from compressed histograms are usable for anomaly determination in a way that avoids bi-modal biases.

With some additional approaches, the determination of anomalous data portions is implemented via a higher criticism statistic.

In this manner, p-values from node activations and obtained from compressed histograms are usable for anomaly determination in a way that avoids undesirable data skewance.

With some additional approaches, the p-values for the extracted activations respectively include ranges of p-values for the extracted activations.

In this manner, ties between bins are better accounted for and biases for higher p-values are avoided to improve predictions of a sample being anomalous.

In another general approach, a computer program product includes a computer readable storage medium having program instructions embodied therewith. The program instructions are readable by a processor to cause the processor to: perform the foregoing method.

In still another general approach, a system includes: a processor as well as logic that is executable by the processor and configured to: perform the foregoing method.

Various aspects of the present disclosure are described by narrative text, flowcharts, block diagrams of computer systems and/or block diagrams of the machine logic included in computer program product (CPP) implementations. With respect to any flowcharts, depending upon the technology involved, the operations can be performed in a different order than what is shown in a given flowchart. For example, depending upon the technology involved, two operations shown in successive flowchart blocks may be performed in reverse order, as a single integrated step, concurrently, or in a manner at least partially overlapping in time.

A computer program product (CPP) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved activation space characterization code at block 150 for using compressed node-specific histograms to compute p-values of observed activations without retaining already-known inputs and characterizing the activation space in a task-independent manner. In addition to block 150, computing environment 100 includes, for example, computer 101, wide area network (WAN) 102, end user device (EUD) 103, remote server 104, public cloud 105, and private cloud 106. In this implementation, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

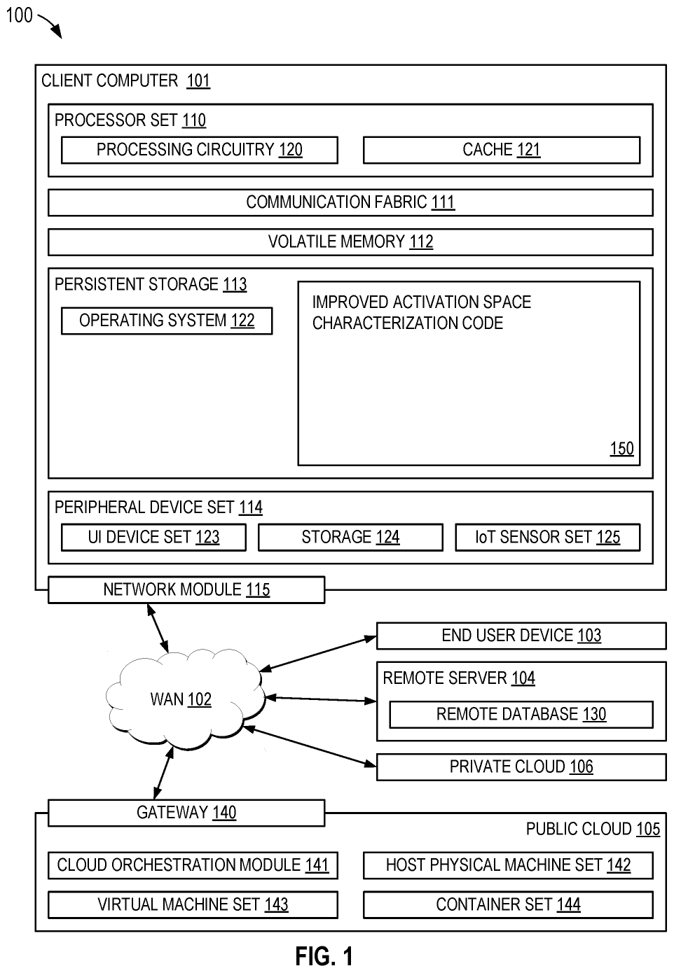

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various implementations, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some implementations, storage 124 may take the form of a quantum computing storage device for storing data in the form of qubits. In implementations where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some implementations, network control functions and network forwarding functions of network module 115 are performed on the same physical hardware device. In other implementations (for example, implementations that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some implementations, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some implementations, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other implementations a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this implementation, public cloud 105 and private cloud 106 are both part of a larger hybrid cloud.

The improved activation space characterization code 150 is software that supplements a machine learning model and receives data, e.g., node activations, from a machine learning model. Such machine learning model is hosted in some approaches also at the computer 101 and/or at a remote server 104 which communicates with the improved activation space characterization code 150. The improved activation space characterization code 150 generates a compressed histogram as a representation of the neural network of the machine learning model. This compressed histogram is stored locally at memory of the computer 101 or remotely, e.g., in memory of the remote server 104 or of another end user device 103. This compressed histogram is accessed subsequently via the improved activation space characterization code 150 for anomalous data determination when further data samples are input into the neural network of the machine learning model. The improved activation space characterization code 150 includes one or more algorithms which creates the compressed histogram based on the neural network and/or on data received from the neural network. The improved activation space characterization code 150 then accesses the compressed histogram for various tasks such as downstream detection tasks in a deployment.

In some aspects, a system according to various implementations may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various implementations.

As noted above, the prevalence of computer systems has increased with the advancement of the Internet, and wireless network standards such as Bluetooth and Wi-Fi. Additionally, the adoption and development of smart devices, e.g., smartphones, televisions, tablets, and other devices in the Internet of Things (IoT), has increased as processing power and functionality improve. Data production continues to increase as computing power advances. For instance, the rise of smart enterprise endpoints has led to large amounts of data being generated at remote locations. Data production will only further increase with the growth of 5G networks and an increased number of connected mobile devices.

As data production increases, so does the overhead associated with processing the larger amounts of data. Processing overhead is further increased when dealing with unstructured data and as different types of information are involved. For example, video and audio data may be combined in a pool of unstructured data, which conventional products have had significant difficulty processing.

Artificial intelligence has been developed in an attempt to combat this rise in processing overhead. For instance, machine learning models may be used to inspect large amounts of data and draw inferences from patterns in the data. While this has reduced the amount of time associated with analyzing data, advancements in artificial intelligence and sample sizes have caused conventional implementations to experience significant issues in terms of performance latency and storage capacity. As a result, conventional products have been suffering from declining performance as data sample sizes and data analysis complexity continue to increase.

For example, the ubiquity of applications that utilize deep neural networks (DNNs) has brought the emergence of a variety of architectures and improvements in the accuracy of deep learning tasks, e.g., such as natural language processing, signal processing, and image processing. Particularly, the evolution of deep learning models has transitioned towards larger sizes, which are not suited for use cases such as federated learning, learning on edge devices, and other low-resource environments that require memory efficient networks to operate realistically. Given the large sizes of most deep learning models, techniques such as parameter pruning, quantization, low-rank factorization, transferred/compact convolutional filters, and knowledge distillation have been proposed to reduce their sizes at inference time.

However, these conventional techniques have not made investigating the behavior of these systems easier, which further limits their use in real-world applications. For instance, conventional techniques depend on the specific tasks, thereby limiting the generalizability (e.g., applicability) of conventional products. Similarly, conventional products retain all the information of the activation space at inference time, making them more susceptible to adversarial attacks and privacy issues.

However, in sharp contrast to these conventional shortcomings, implementations herein are able to characterize the activation space in DNNs using compressed node-specific histograms to compute p-values of observed activations without retaining already-known inputs. Implementations herein are also able to characterize the activation space in DNNs in a task-independent manner, e.g., as will be described in further detail below.

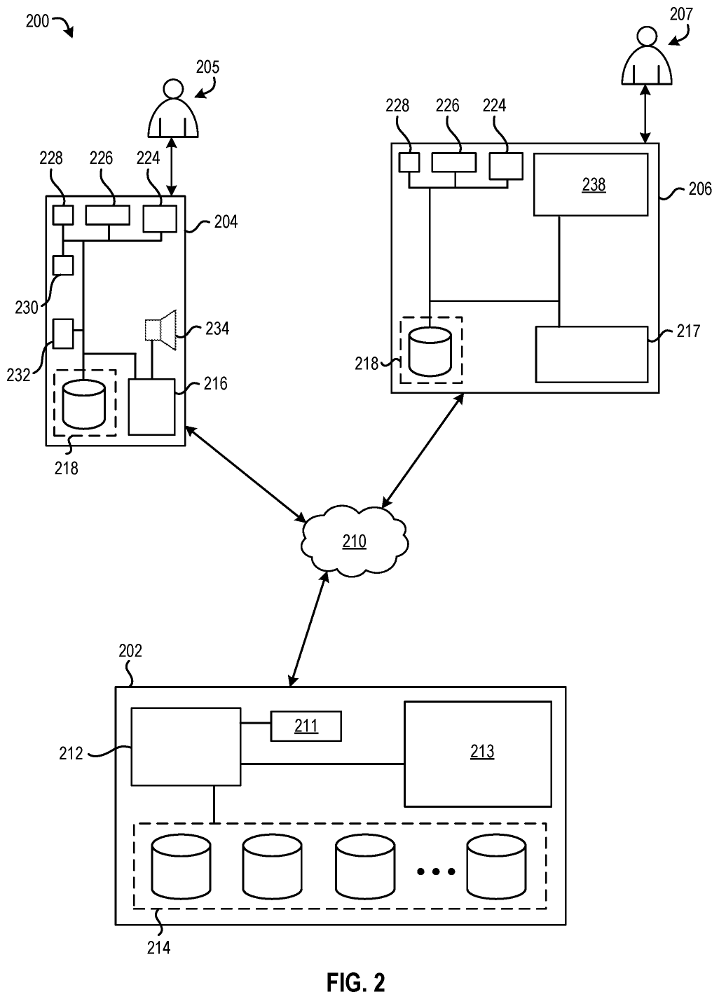

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data” and “information” herein is in no way intended to be limiting either, and may include any desired type of details, e.g., depending on the type of operating system implemented on the user device 204, edge node 206, and/or central server 202. For example, video data, audio data, sensor data, images, etc. may be sent to the central server 202 from user device 204 and/or edge node 206 for processing using one or more machine learning models, e.g., as will soon become apparent.

With continued reference to FIG. 2, the central server 202 includes a large (e.g., robust) processor 212 coupled to a cache 211, a machine learning module 213, and a data storage array 214 having a relatively high storage capacity. The machine learning module 213 may include any desired number and/or type of machine learning models. In preferred approaches, the machine learning module 213 and/or processor 212 includes a deep neural network that has been trained to characterize the activation spaces therein using compressed node-specific histograms. The deep neural network may include a convolutional neural network (CNN), a generative adversarial network (GAN), a graph convolutional policy network (GCPN), etc., or any desired type of deep neural network. For example, applications including Bidirectional Encoder Representations from Transformers (BERT), Generative Pre-trained Transformer (GPT), and others may be used to actually evaluate the activation spaces. Implementations herein can thereby compute p-values of observed activations without retaining already-known inputs and characterize the activation space of the deep neural network in a task-independent manner, e.g., as will be described in further detail below.

Looking to user device 204, a processor 216 coupled to memory 218 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Some data may be received from user 205 for storage and/or evaluation using machine learning module 213. The data may be received as a result of the user 205 using one or more applications, software programs, temporary communication connections, etc. running on the user device 204. For example, the user 205 may upload data for storage at the data storage array 214 and evaluation using processor 212 and/or machine learning module 213 of central server 202. As a result, the data is evaluated and processed.

Looking now to the edge node 206 of FIG. 2, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to a machine learning module 238. As described above with respect to machine learning module 213, the machine learning module 238 may include any desired number and/or type of machine learning models. It follows that machine learning module 238 may implement similar, the same, or different characteristics as machine learning module 213 in central server 202.

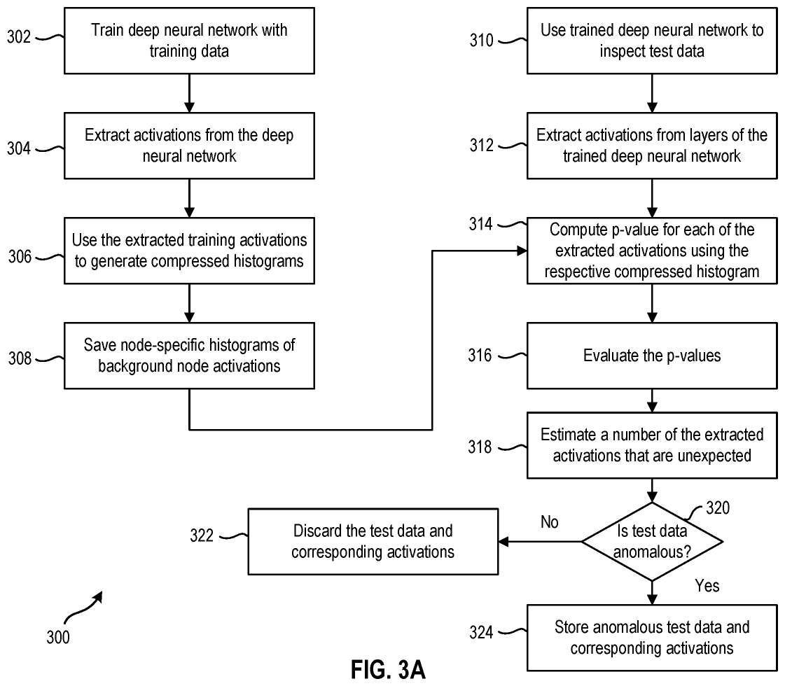

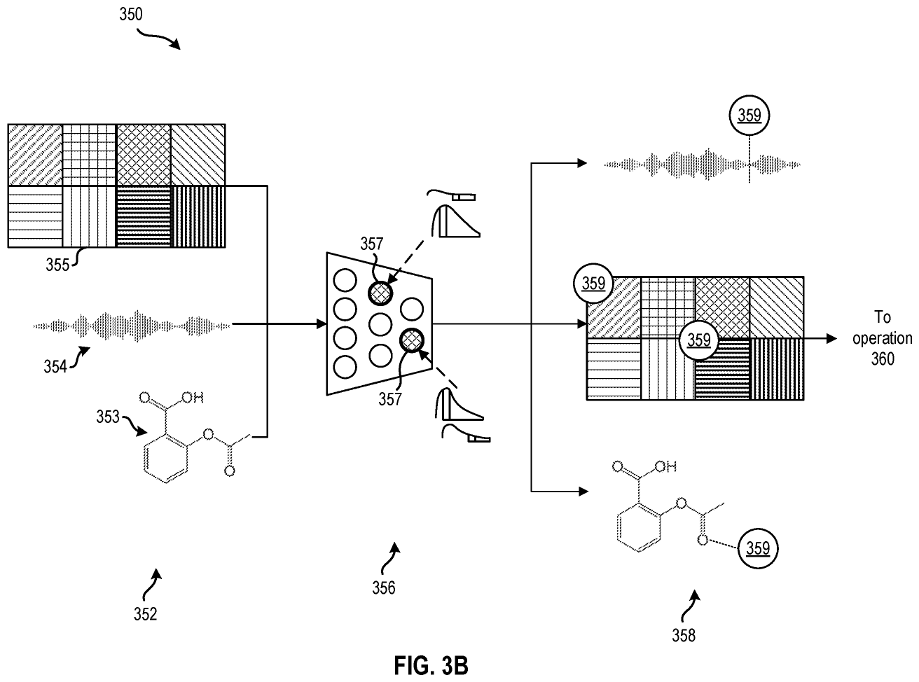

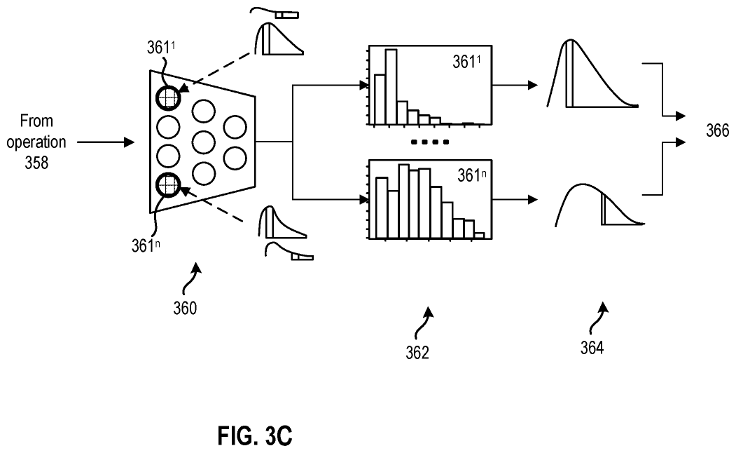

Looking now to FIG. 3A, a flowchart of a computer-implemented method 300 is shown for characterizing the activation spaces of machine learning models using compressed node-specific histograms. In other words, method 300 is able to compute p-values of observed activations without retaining already-known inputs and characterize the activation space in a task-independent and model-agnostic manner. Method 300 also includes operations associated with training the machine learning models to evaluate data and identify these activations, e.g., as will soon become apparent.

Method 300 may be performed in accordance with any of the environments depicted in FIGS. 1-2, among others, in various approaches. Of course, more or less operations than those specifically described in FIG. 3A may be included in method 300, as would be understood by one of skill in the art upon reading the present descriptions. Each of the steps of the method 300 may be performed by any suitable component of the operating environment using known techniques and/or techniques that would become readily apparent to one skilled in the art upon reading the present disclosure. For example, one or more processors located at a central server of a distributed system (e.g., see processor 212 of FIG. 2 above) may be used to perform one or more of the operations in method 300. In another example, one or more processors are located at an edge server (e.g., see controller 217 of FIG. 2 above).

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

FIG. 3A illustrates the training and application of machine learning models to evaluate incoming information. Accordingly, operation 302 includes evaluating received training data using a machine learning model. More specifically, operation 302 includes evaluating the received training data using an original (e.g., pre-trained) version of a deep neural network. With respect to the present description, it should be noted that the term “pre-trained” as used herein in the context of pre-trained deep neural networks is intended to refer to a deep neural network that has been developed to perform a certain type of task, (e.g., such as object detection), but which has not been trained on the data produced by a system in real-time. It follows that the original version of the deep neural network is trained by evaluating the training data and developing inferences based on identified patterns and correlations, e.g., as would be appreciated by one skilled in the art after reading the present description.

Any desired type of pre-trained neural network that may be used to perform downstream detection tasks may be used to evaluate the received training data in operation 302. For example, the deep neural network may include a CNN, a GAN, a GCPN, etc., or any desired type of deep neural network. Training the neural network may thereby involve evaluating the intermediate layers of the model, with each layer consisting of “N” nodes. This evaluation may allow for the activation space of the DNN to be characterized efficiently and in a generalizable way. In one example, representation of activations in deep neural networks can be developed by creating node-specific histograms that represent the activation space using efficiently driven p-values, e.g., as will soon become apparent.

Proceeding to operation 304, activations that result from evaluating the training data are extracted from layers of the pre-trained deep neural network. In other words, the intermediate layers of the pre-trained deep neural network are inspected to determine the layers that include nodes which experienced an activation caused by evaluating the training data.

In a neural network, e.g., a deep neural network, node activations are typically represented as numerical values as opposed to binary values. These numerical values represent the intensity or strength of activation for each node in the network and are also known as the “activation level” or “output” of the node. These values can be any real number within a certain range, and they represent the response of the node to the input data. The reason for using continuous activation values is to enable the network to perform complex, non-linear computations. These values are crucial for optimization techniques that the model uses to adjust its parameters during training to improve its performance. The neural network has an activation function that defines the range for which to consider a node output as having been “activated”.

Neural networks such as deep neural networks have a built-in ability to determine if their nodes are activated. In the architecture of neural networks, there are activation functions which set the threshold of the activation level. Each node receives input (in form of real valued numbers) from one or more nodes in the previous layer (or directly from the input data for the first layer). These inputs are multiplied by a weight. These weights are parameters learned during training and determine the importance of each input for the node. From these various inputs/modifiers, the products of inputs and weights are summed together to produce a single output value for the node. This value represents the combined influence of the inputs. The weighted sum is then passed through an activation function which determines the activation value of the node. Common activation functions include the sigmoid, tanh, ReLU (Rectified Linear Unit), and others. Different neural networks use different activation functions so the level of activation will be different across models.

Nodes are considered “activated” when their output value exceeds a certain threshold. The threshold is typically determined by the choice of activation function. Nodes can also be “activated” but with different levels of intensity, depending on the activation function and the magnitude of the weighted sum and output value.

Various tools and techniques are implementable to visualize and understand neural network behavior and specific node behavior during training and inference of a neural network. Some popular frameworks and libraries, e.g., open-source software libraries, provide visualization tools that allow node activations and gradients to be obtained, seen, and evaluated during training/inference. Additionally, various debugging and visualization software libraries provide interactive dashboards for monitoring and visualizing node activations, loss values, and other important information during neural network training/inference. Software programming is used to implement the improved activation space characterization code 150 to connect with/receive node activation information correctly from neural networks with various designs. Such programming can be applied after receiving a neural network model for which the improved activation space characterization code 150 is to perform sample anomaly detection and from which the improved activation space characterization code 150 is to receive node activation information.

The activation space of deep neural networks may be studied for multiple purposes, including fairness and robust explanation. Deep neural networks may also be evaluated for downstream purposes, e.g., such as detection of adversarial attacks and synthesized content. Given the size and heterogeneous nature of deep neural networks, identifying a generalizable and efficient representation of activations is desirable.

Implementations herein use node-specific histograms to compute p-values of observed activations without retaining already-known inputs so that memory resource consumption savings and increased privacy protection are achieved. These implementations have shown great potential, as they may be applied to various network architectures across multiple downstream tasks, compared with the kernel density estimates, and brute-force empirical baseline. As a result, implementations herein have been tested to result in a 30% decrease in memory usage while also achieving up to 4 times faster p-value computing times and maintaining state-of-the-art detection power in downstream tasks.

Referring still to FIG. 3A, operation 306 includes using the extracted activations during training to generate compressed histograms. The compressed histograms that are generated are preferably node-specific. In other words, a compressed histogram is preferably developed for each node that experienced at least some of the extracted activations as a result of evaluating the training data. Moreover, each subset of the extracted activations are used to create one of the compressed histograms for a respective node of the original, pre-trained version of the deep neural network. The node-specific histograms may be represented as bin edges which correspond to the number of bins as well as boundaries for each bin and heights, for each node in the background activations of the given implementation.

According to an in-use example, which is in no way intended to be limiting, a histogram is generated for each node, where performance of the given node is represented by the number of bins and the height of the bins in the histogram. For instance, the heights may be used to represent the number (e.g., count) of activations that fall into a specific bin. Accordingly, because nodal activations can cause spikes that will affect the number of bins, improved activation space characterization code 150 distinguishes between node activation samples within a mode (largest class) and node activation samples that are outside the mode. The improved activation space characterization code 150 generates one bin for the mode (largest class) . . . . The nodal activations are assigned a unique bin within the respective histogram. For activations that are outside of the mode class, the width and number of bins may be determined using Equation 1 and Equation 2 below. The number of bins may be assigned by the improved activation space characterization code 150 by determining the maximum (or “greater”) value between (i) the Freedman Diaconis estimator, and (ii) the Sturges estimator. For instance, the width of the bins and the number of bins may be determined by identifying a maximum value output by Equation 1 (Freedman Diaconis) and Equation 2 (Sturges).

$$h = 2 \frac{IQR}{\sqrt[3]{n}} \qquad Equation 1$$

Equation 1 may be used to determine the width “h” of a given bin in the histogram. This width is based on the interquartile range “IQR” as well as the size of the data “n.” The number of bins nₕ is then determined using nₕ=(max−min)/h where max is the maximum value, min is the minimum value, and the h is the bin width determined from Equation 1.

$${n}_{h} = {log}_{2} ( n ) + 1 \qquad Equation 2$$

The number of bins “nn” in the histogram may be determined using Equation 2 above. The value output is shown as being dependent on the size of the data “n.” This width that is output may be used to compute the information used to form a given compressed histogram. At least some approaches include taking the maximum of the bin number found through Equation 1 (and the additional calculation) and the bin number found through Equation 2. In at least some approaches, the final number of bins for a respective histogram includes these non-modal bins (the number of which being determined in the above-described manner) along with the modal bin. It follows that the number of bins in each histogram takes into account the data size and variability in the data. As a result, the bin-width of the histograms is non-uniform. The histograms may be differentiated by the form of the bin edges included therein. These differentiated bin edges convey the number of bins as well as the boundaries for each bin and the height (i.e., count of elements) of each bin. The bin that corresponds to a test activation may be identified by automatic searching of the bin edges of the histogram corresponding to the given node. The height of the obtained bin may be used to determine (e.g., compute) the corresponding p-value, e.g., as will soon become apparent.

It follows that operation 306 may be repeated any desired number of times to create a desired number of compressed histograms for the nodes of the deep neural network that experienced activations. Each of the compressed histograms may thereby represent the activations that were experienced for a given one of the nodes in the deep neural network. Each bar of the histogram may be used to represent activations experienced by the respective node that are similar in nature to each other. These compressed histograms are thereby able to characterize the activation space in deep neural networks while also retaining a minimal amount of information about the activation space. The node-specific histograms are able to learn the p-value representations of the activations of nodes in the intermediate layers of a neural network. This also reduces exposure to external attacks and privacy issues by creating a compressed (e.g., simplified) representation of the experienced activations and the data that caused the activations.

Implementations herein are thereby able to develop model and task agnostic characterizations of the pre-trained deep neural network. The improvements achieved herein may thereby be applied to any model involving downstream detection tasks, e.g., object detection, image segmentation, facial recognition, image captioning, etc. This desirably reduces memory demand for downstream detection tasks, in addition to reducing runtimes, thereby achieving efficient processing even in situations involving limited resources.

From operation 306, method 300 proceeds to operation 308. There, operation 308 includes storing the compressed histograms in memory. As noted above, the compressed histograms provide a valuable insight into the inner workings of a neural network and how it interprets data. The compressed histograms are also able to convey this information using significantly less data than has been conventionally associated with doing so. Storing the compressed histograms thereby provides the ability to access node-specific performance of the neural network as desired. The stored compressed histograms allow for newly received data to be processed efficiently. The previously learned performance of the different nodes and layers of nodes may be applied to perform, or at least predict, downstream detections. Accordingly, method 300 is shown as proceeding from operation 308, directly to operation 314 where ranges of p-values are determined for various nodes of a trained version of the deep neural network, using the node-specific and compressed histograms, e.g., as will be described in further detail below.

It follows that, operations 302, 304, 306, and 308 may be used to train a deep neural network to learn the expected pattern of the data and to build the histogram program to recognize anomalous data. In other words, operations 302, 304, 306, and 308 may be used to learn the distribution of normal data and build the compressed histograms. Thus, abnormal test data may be identified using the histograms which have been trained to detect the abnormality using p-values. The process of inspecting and evaluating training data using the deep neural network allows for inferences to be drawn based on the patterns identified. Moreover, the compressed histograms retain these patterns using a significantly small amount of information. Accordingly, the trained version of the deep neural network is able to access and apply the compressed histograms while evaluating newly received information. For instance, the compressed histograms may be used to efficiently determine p-values for each of the node activations experienced by the pre-trained deep neural network, e.g., as will soon become apparent.

Looking now to operation 310, a new set of test data is received and evaluated using the pre-trained deep neural network. In other words, the deep neural network deployed to perform a specific down-stream task is used to inspect the received test data. With respect to the present description, “test data” may include any desired type of information which may be presented in a number of different formats depending on the situation (e.g., depending on the operating system implemented in a computer network). For example, the “test data” may be of one or more types, e.g., such as image data, audio data, sensor readings and related information, etc. In addition to being of different types, the test data may be represented in different formats. For example, image data may be represented as a .jpg file, a .png file, a .pdf file, etc.; audio data may be represented as a .mp3 file, a .wav file, a .wma file, etc. As noted above, implementations herein are able to provide model and/or task agnostic characterizations of test data based on the patterns identified while evaluating the training data. The broad applicability of the improvements achieved herein may thereby be applied to any model that produces test data involving downstream detection tasks, e.g., such as object detection, image segmentation, facial recognition, image captioning, etc., regardless of the type and/or format of the test data associated with the model and/or the downstream detection tasks. The pre-trained deep neural networks herein may thereby be used to evaluate various types and/or formats of test data.

Certain nodes in the various layers of the pre-trained deep neural network are activated as a result of inspecting the test data. Accordingly, operation 312 includes extracting activations from layers of the deep neural network in response to evaluating the test data. The activations may be identified by inspecting each of the layers in the deep neural network and identifying layers that include one or more nodes that have been activated by the test data. These identified layers may further be evaluated to identify the specific nodes that have been activated, e.g., as would be appreciated by one skilled in the art after reading the present description.

The nodes identified as having been activated are evaluated further to determine how each of the activations at least partially impact the downstream detections (e.g., tasks) that are made based on the test data. Accordingly, operation 314 includes computing a p-value for each of the extracted activations using the respective one of the compressed histograms. In other words, operation 314 includes using the node-specific compressed histograms developed while training the deep neural network used to evaluate the test data and determine (e.g., compute) p-values for each of the extracted activations. With respect to the present description, a “p-value” is intended to refer to a value that represents a statistical metric which measures the probability there is no relationship between two or more variables. Thus, a low p-value typically provides evidence against the null hypothesis, e.g., as would be appreciated by one skilled in the art after reading the present description. It should also be noted that any p-value that is computed herein may actually include a range of p-values. For example, a range of p-values may be computed for each of the extracted activations to avoid situations. The range of p-values may give a better representation of each of the extracted activations in some approaches.

As noted above, these compressed histograms are developed for the nodes in the various layers of the deep neural network by evaluating how the various nodes react to different information. Based on this evaluation, patterns and other relationships can be identified and used to develop the compressed histograms. Referring still to operation 314, it follows that a p-value may be determined for each node that experienced an activation as a result of evaluating the test data. The extracted activations may thereby be evaluated to determine a node of the deep neural network that each of the respective activations correspond to. Each of the activations may be compared to a respective one of the compressed histograms to compute a p-value for the given activation. It follows that details associated with the activation (e.g., activation strength) may be used as an input variable, where the histogram indicates the specific p-values that correspond to different scenarios (e.g., input variables).

P-values may be determined for each test activation. P-values may be used to measure how irregular a given activation value at a particular node is. A p-value thereby represents the proportion of activations from the background input that are greater than or equal to the observed test activation. Thus, given a histogram for a given node, p-values may be obtained using the height (e.g., count of elements) of the bins from the histogram. This means that the p-values will correspond to their respective bins, and therefore test activations that fall into the same bin will have a same p-value. The p-value is defined in some approaches as a range between a maximum value and a minimum value, to account for statistical ties. According to an in-use example, which is in no way intended to be limiting, Equation 3 below may be used to determine a given p-value “pᵢⱼ^{k}”. Moreover, Equation 3.1 and Equation 3.2 may be used to further define the variables shown in Equation 3.

$${p}_{lj}^{k} = [ {P}_{min} ( {p}_{lj}^{k} ) , {P}_{max} ( {p}_{lj}^{k} ) ] \qquad Equation 3$$

$${P}_{min} ( {p}_{lj}^{k} ) = \frac{{N}_{B} - {\sum }_{i = {b}_{kj + 1}}^{{b}_{nj}} {C}_{ij}}{{N}_{B} + 1} \qquad Equation 3.1$$

$${P}_{max} ( {p}_{lj}^{k} ) = \frac{{N}_{B} - {\sum }_{i = {b}_{kj}}^{{b}_{nj}} {C}_{ij} + 1}{{N}_{B} + 1} \qquad Equation 3.2$$

Here, “bₖⱼ” represents the bin of the k^{th} test activation of the given node, and “bₙⱼ” represents the n^{th} bin in the histogram of the node having “n” total bins. Furthermore, “Cᵢⱼ” represents the count (e.g., height) of the i^{th} bin in the histogram. NB represents the total number of samples in the training data that were considered to produce a normal range of the node activation value.

The distribution of the histogram p-values may be compared with a distribution of empirical p-values. For example, goodness-of-fit statistics may be used to compare how well the p-values corresponding to previous performance align with what is actually experienced. In some examples, which are in no way intended to be limiting, two-sample Kolmogorov-Smirnov tests may be used to determine whether the distributions of the empirical and node-specific histograms p-value representations are sufficiently similar. To compare the p-value distributions of the baselines, p-values may be drawn uniformly at random from each range defined as [Pₘᵢₙ(p^{k}ᵢⱼ), Pₘₐₓ(p^{k}ᵢⱼ)]. Moreover, the test may be applied to these drawn values, e.g., as would be appreciated by one skilled in the art after reading the present description.

With continued reference to FIG. 3A, operation 316 includes evaluating the determined p-values, while operation 318 includes estimating a number of the extracted activations that are unexpected. In other words, operation 318 includes determining a proportion of the activations extracted in operation 312, that were determined to deviate from what is predicted to occur. As noted above, p-values measure the probability there is no relationship between two or more variables. By evaluating the p-values in operation 316, determinations may be made as to whether the activations those p-values correspond to align with what the deep neural network has been trained to predict.

In some approaches, all of the test data may be evaluated together. Thus, operation 318 may involve determining whether all of the received test data has resulted in predicted behavior. However, perceived actions may diverge from what is predicted. Operation 320 thereby determines whether at least a portion of the test data is anomalous. The number of unexpected activations estimated in operation 318 may be used at least in part to determine whether the test data is anomalous. For example, a portion of test data that caused a high number of unexpected activations to occur may be identified as an anomalous sample. However, a portion of test data resulting in a low number of unexpected node activations may be identified as not being anomalous.

In at least some approaches, the anomalousness determination of step 320 occurs via the improved activation space characterization code 150 performing non-parametric scan statistics on the p-values from steps 314, 316, and/or 318. A set of p-values from the neural network node activations is input, e.g., automatically input, into the improved activation space characterization code 150 and, in response, the improved activation space characterization code 150 generates an output of a score. Non-parametric scan statistics can be referred to as “tests of tests.” Every node activation of the neural network creates a p-value. The p-value indicated how much ‘in the tai’ the activation is relative to a reference distribution. For example, if the activation is larger than 97% of the reference activations the activation has a right p-value of 0.03. If the activation is smaller than 94% of the reference distributions, then the activation has a left p-value of 0.06. A neural network contains many nodes and a p-value is created for every node, so that many p-values are generated. The p-values are evaluated as a group with respect to a specific sample that was input into the neural network.

In at least some approaches, non-parametric scan statistics on the p-values are implemented via higher criticism. In at least some approaches a higher criticism statistic is defined using Equation 4, as follows:

$${φ}_{HC} ( α , {N}_{α} , N ) = \frac{{N}_{α} - N α}{\sqrt{N α ( 1 - α )}} \qquad Equation 4$$

The higher criticism statistic makes minimal assumptions on the underlying distribution of node activations. Using minimal assumptions instead of many assumptions helps avoid high skewance and bi-modal biases. For example, for a neural network with 100 nodes and an “in the tail” of any p-value that is smaller than α=0.07, 7 activations out of 100 are expected in the respective tails. If 15 activations in the tails are observed, then the higher criticism statistic (or “score”) is computed via (15−7)/(sqrt (100 (0.07*(1−0.07))))=3.135 which indicates a measure of anomaly.

In another approach, the anomaly is determined using naïve non-parametric can statistics without subset scanning. If a neural network has 100 nodes and there are 50 tokens/sentences that each have 100 activations, then a total of 5000 (i.e., 50*100) p-values are produced. Those p-values are passed into higher criticism in the code 150 to obtain a score to determine if those 5000 p-values are uniformly distributed. No scanning is involved or required.

In other approaches, other statistical approaches such as other types of NPSS or parametric scoring functions (e.g., Gaussian, Poisson, etc.) are implemented to determine anomaly of the p-values and node activations.

In response to determining that the test data (or at least a portion of the test data) is not anomalous, method 300 proceeds from operation 320 to operation 322. There, operation 322 includes discarding the portion of the test data and the corresponding extracted activations. In other words, operation 322 includes discarding any data and/or evaluation results that aligned with the expected distribution. This prevents redundant data from being stored, thereby reducing the overall footprint of the deep neural network and improving performance efficiency.

Alternatively, in situations where it is determined that the test data (or at least a portion thereof) is anomalous, method 300 proceeds to operation 324 from operation 320. In other words, method 300 advances to operation 324 in response to determining that a significant divergence from expected performance has been identified. There, operation 324 includes storing the anomalous portion of the test data as well as the corresponding extracted activations. In other words, operation 324 includes storing performance information that diverges from what the pre-trained deep neural network expected to occur.

In response to retaining portions of the test data that are determined as being anomalous based at least in part on the evaluation of the p-values, the anomalous information may be used to update (e.g., retrain) the deep neural network. Although not shown, method 300 may thereby further cause the deep neural network to be retrained using the retained portions of the test data that are determined as being anomalous. For instance, in some approaches, method 300 may include causing the deep neural network to be retrained periodically, randomly, in response to receiving a request from a user, in response to a predetermined condition being met (e.g., a predetermined amount of test data having been evaluated), etc., over time as a result of real-time use.

For example, in some instances the anomalous data sample is forwarded to a subject matter expert who is able to recognize and label the sample. The sample and the label are then input together to the neural network to allow the neural network to adjust its parameters to recognize this sample and correctly infer similar samples that it receives in the future.

In the domain of adversarial attacks, anomalous samples sometimes represent deliberate and malicious attempts to manipulate a deployed machine learning model to deceive same and negatively affect the inference/decision-making process. These attacks are often designed to exploit vulnerabilities in the behavior of the neural network model, causing the neural network to produce incorrect or unintended outputs. With the present approaches and compressed histogram, in a cyber security application the system can detect the anomalous sample and block access to same and sends the event and/or sample remotely to system administrators who can monitor the situation and improve their defense processes for the neural network.

In other cases, an anomalous sample is detected and sent to a repair program to repair the sample so that the neural network is thereafter able to perform inference on the sample. For example, for a neural network that is part of control system of an autonomous driving car that has a camera sensor and a system to detect objects in front of the car, the system receives and/or captures an image of a stop sign that has a patch or a sticker obscuring the sign. The car/autonomous driving system does not know how to process the image as it does not realize the image represents a stop sign. Thus, the control system might not correctly control the car to brake and stop at the stop sign. With the compressed histogram program, the control system of the car can recognize the anomalous data, feed the anomalous data to an image patching program, and the image patching program applies image processing techniques to repair the image. The repaired image is fed back to the neural network detection system. After receiving this corrected image, the car then performs the intended action and stops for the stop sign. Under this approach, there is not a need to retrain the neural network.

Implementations herein are able to develop model and task agnostic characterizations of the input training data. The improvements achieved herein may thereby be applied to any model involving downstream detection tasks, e.g., such as object detection, image segmentation, facial recognition, image captioning, etc. This desirably reduces memory demand for downstream detection tasks, in addition to reducing runtimes, thereby achieving efficient processing even in situations involving limited resources.

Looking to FIG. 3B, the progression of a method 350 for characterizing the activation spaces of machine learning models using compressed node-specific histograms is shown in accordance with one approach. In other words, method 350 is able to compute p-values of observed activations without retaining already-known inputs and characterize the activation space in a task-independent manner. Method 350 also includes operations associated with training the machine learning models to evaluate data and identify these activations, e.g., as will soon become apparent.

Method 350 may be performed in accordance with any of the environments depicted in FIGS. 1-2, among others, in various approaches. Of course, more or less operations than those specifically described in FIG. 3B may be included in method 350, as would be understood by one of skill in the art upon reading the present descriptions. Each of the steps of the method 350 may be performed by any suitable component of the operating environment using known techniques and/or techniques that would become readily apparent to one skilled in the art upon reading the present disclosure. For example, one or more processors located at a central server of a distributed system (e.g., see processor 212 of FIG. 2 above) may be used to perform one or more of the operations in method 350. In another example, one or more processors are located at an edge server (e.g., see controller 217 of FIG. 2 above).

Moreover, in various approaches, the method 350 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 350. Illustrative processors include, but are not limited to, a central processing unit (CPU), an application specific integrated circuit (ASIC), a field programmable gate array (FPGA), etc., combinations thereof, or any other suitable computing device known in the art.

FIG. 3B illustrates the training and application of machine learning models to evaluate incoming information. Accordingly, operation 352 includes receiving different types of input data and evaluating the received data. For instance, operation 352 is illustrated as receiving chemical-based information 353, audio-based information 354, and image and/or video based information 355.

Proceeding to operation 356, the received information is evaluated using a pre-trained machine learning model, e.g., such as a deep neural network. Operation 356 also includes identifying the specific nodes in the machine learning model that were activated as a result of evaluating the received test information. Accordingly, activated nodes 357 have been identified. Performance of the nodes that have been activated may also be evaluated and used to generate alternate information. For example, performance of activated nodes 357 has been represented graphically. As alluded to above, these graphical representations capture a simplified (e.g., compressed) overview of how the respective nodes have been observed performing.

These graphical representations and other information associated with the identified node activations may further be used to evaluate the originally received data, identify patterns, and make inferences. For instance, callouts 359 indicate incorrect (e.g., fake, improperly modified, corrupt, etc.) portions of the originally received information. For example, a portion of the received image and/or video based information may be identified as a deepfake, generated from scratch using artificial intelligence, an infringement of an existing copyright, etc.

The information output as a result of evaluating the test data may be used to train the deep neural network used to originally inspect the test data. In other words, operation 358 may further include training the deep neural network such that the deep neural network is able to interpret newly received data. Accordingly, as shown further in FIG. 3C operation 360 includes evaluating newly received data using the pre-trained deep neural network. As shown, some of the nodes 361¹, . . . , 361ⁿ in the deep neural network are activated as a result of evaluating the new test data. These activated nodes 361¹, . . . , 361ⁿ are identified and used to access certain compressed histograms. As noted above, a compressed histogram may be developed for each of the nodes in a deep neural network over time, e.g., as the deep neural network continues to be trained. Accordingly, operation 362 includes accessing the compressed histograms which correspond to activated nodes 361¹, . . . , 361ⁿ. The compressed histograms may be stored in memory and loaded into a cache or controller as a result of performing operation 362.

As shown, the compressed histograms for activated nodes 361ⁿ, . . . 361ⁿ include a number of bins and the boundaries of each bin as well as count of elements in each bin, which may be used to determine p-values for the respective nodes. For example, details corresponding to the node activations 361¹, . . . , 361ⁿ may be used as an input value to determine the appropriate p-value to assign to the respective node. It follows that the same p-value may be assigned to nodes that exhibit similar activations. In other words, activated nodes that fall within the same bin of the compressed histogram may be assigned the same p-value.

From operation 362, method 350 proceeds to operation 364. There, operation 364 includes converting the relevant portions of the compressed histograms and comparing the predicted outcomes. As noted above, the distribution of historical p-values may be compared with a distribution of the empirical p-values. For example, goodness-of-fit statistics may be used to compare how well the p-values corresponding to previous performance align with what is actually experienced. In some examples, which are in no way intended to be limiting, two-sample Kolmogorov-Smirnov tests may be used to determine whether the distributions of the empirical and node-specific histograms p-value representations are sufficiently similar. To compare the p-value distributions of the baselines, p-values may be drawn uniformly at random from each range defined as [Pₘᵢₙ(p^{k}ᵢⱼ), Pₘₐₓ(p^{k}ᵢⱼ)]. Moreover, the test may be applied to these drawn values, e.g., as would be appreciated by one skilled in the art after reading the present description.

As a result, the deep neural network outputs a result at operation 366. The result that is output may be used to determine a next action. In some approaches, the output may be used as an input for a downstream task (e.g., detection). For example, the result output at operation 366 may be used to indicate a predetermined portion of an image, flag a particular portion of an audio sample, etc. It follows that method 350 may be able to evaluate a variety of different input data types and perform complex evaluations of the data by utilizing compressed histograms to predict performance.

Implementations herein are desirably able to characterize the representations of deep learning models in order to facilitate downstream detection tasks. Moreover, this characterization is model-agnostic, and therefore can be applied to any desired deep learning framework efficiently. The characterization is also task-agnostic and can be applied to various downstream tasks, e.g., such as fake image detection, adversarial attack detection in audio systems, etc. The characterization that is performed is further simplified using node-specific histograms, desirably resulting in reduced memory usage at inference time, reduced compute time, and improved privacy by implementing compressed data representations.

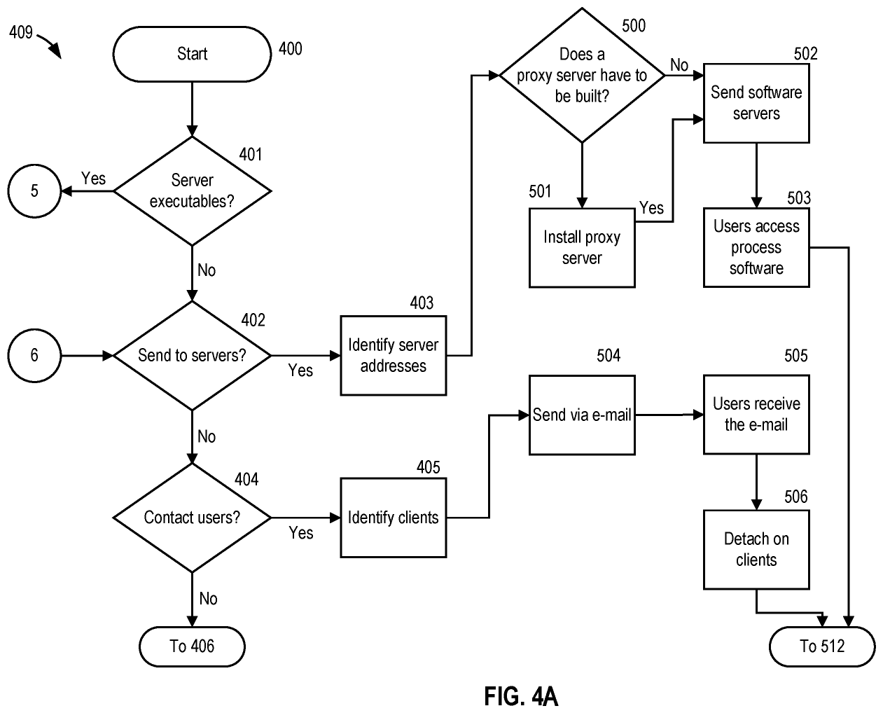

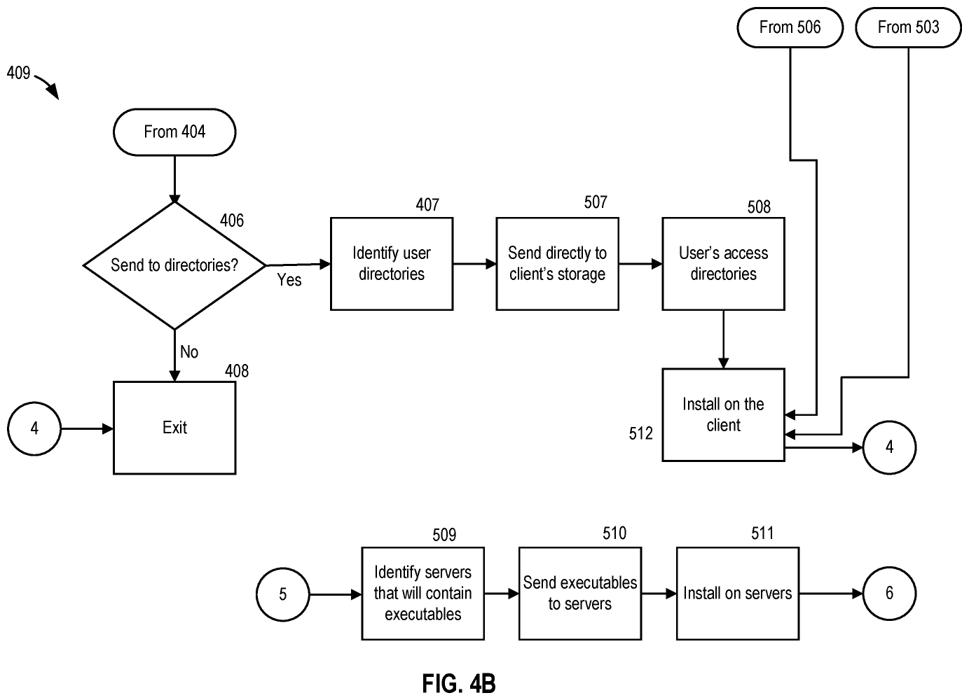

Now referring to FIGS. 4A-4B, a flowchart of a method 409 is shown according to one approach. The method 409 may be performed in accordance with any of the environments depicted in FIGS. 1-3C, among others, in various approaches. Of course, more or fewer operations than those specifically described in FIGS. 4A-4B may be included in method 409, as would be understood by one of skill in the art upon reading the present descriptions.

Each of the steps of the method 409 may be performed by any suitable component of the operating environment. For example, in various approaches, the method 409 may be partially or entirely performed by a processing circuit, e.g., such as an IaC access manager, or some other device having one or more processors therein. The processor, e.g., processing circuit(s), chip(s), and/or module(s) implemented in hardware and/or software, and preferably having at least one hardware component, may be utilized in any device to perform one or more steps of the method 409. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software associated with using compressed node-specific histograms to compute p-values of observed activations without retaining already-known inputs and characterizing the activation space in a task-independent manner, may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

With continued reference to method 409, step 400 begins the deployment of the process software. An initial step is to determine if there are any programs that will reside on a server or servers when the process software is executed (401). If this is the case, then the servers that will contain the executables are identified (509). The process software for the server or servers is transferred directly to the servers' storage via FTP or some other protocol or by copying through the use of a shared file system (510). The process software is then installed on the servers (511).

Next, a determination is made on whether the process software is to be deployed by having users access the process software on a server or servers (402). If the users are to access the process software on servers, then the server addresses that will store the process software are identified (403).

A determination is made if a proxy server is to be built (500) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (501). The process software is sent to the (one or more) servers either via a protocol such as FTP, or it is copied directly from the source files to the server files via file sharing (502). Another approach involves sending a transaction to the (one or more) servers that contained the process software, and have the server process the transaction and then receive and copy the process software to the server's file system. Once the process software is stored at the servers, the users, via their client computers, then access the process software on the servers and copy to their client computers file systems (503). Another approach is to have the servers automatically copy the process software to each client and then run the installation program for the process software at each client computer. The user executes the program that installs the process software on the client computer (512) and then exits the process (408).

In step 404 a determination is made whether the process software is to be deployed by sending the process software to users via e-mail. The set of users where the process software will be deployed are identified together with the addresses of the user client computers (405). The process software is sent via e-mail (504) to each of the users' client computers. The users then receive the e-mail (505) and then detach the process software from the e-mail to a directory on their client computers (506). The user executes the program that installs the process software on the client computer (512) and then exits the process (408).

Lastly, a determination is made on whether the process software will be sent directly to user directories on their client computers (406). If so, the user directories are identified (407). The process software is transferred directly to the user's client computer directory (507). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (508). The user executes the program that installs the process software on the client computer (512) and then exits the process (408).

It will be clear that the various features of the foregoing systems and/or methodologies may be combined in any way, creating a plurality of combinations from the descriptions presented above.

It will be further appreciated that implementations of the approaches described herein may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method, comprising:
receiving a new set of test data;
evaluating the test data using a pre-trained deep neural network;
extracting activations from layers of the deep neural network in response to evaluating the test data;
using compressed histograms to determine p-values for the extracted activations;
evaluating the determined p-values; and
retaining portions of the test data that are determined as being anomalous based at least in part on the evaluation of the p-values.

2. The computer-implemented method of claim 1, wherein using compressed histograms to determine the p-values for the extracted activations includes, for each of the extracted activations:
determining a node of the deep neural network that a given extracted activation corresponds to;
comparing the given extracted activation to a compressed histogram correlated with the node that the given extracted activation corresponds to; and
computing a p-value for the given extracted activation.

3. The computer-implemented method of claim 1, wherein the compressed histograms are node-specific.

4. The computer-implemented method of claim 1, wherein retaining portions of the test data that are determined as being anomalous based at least in part on the evaluation of the p-values includes:
estimating a number of the extracted activations that are unexpected;
using the estimated number to determine whether at least a portion of the test data is anomalous; and
in response to determining that a portion of the test data is not anomalous, discarding (i) the portion of the test data, and (ii) the corresponding extracted activations.

5. The computer-implemented method of claim 4, comprising:
in response to determining that another portion of the test data is anomalous, storing (i) the anomalous portion of the test data, and (ii) the corresponding extracted activations.

6. The computer-implemented method of claim 1, comprising, producing the compressed histograms by:
evaluating training data using the deep neural network;
extracting training activations from layers of the deep neural network in response to evaluating the training data;
using the extracted training activations to generate the compressed histograms; and
storing the compressed histograms.

7. The computer-implemented method of claim 6, wherein using the extracted training activations to generate the compressed histograms includes:
for each node of the deep neural network that corresponds to a subset of the extracted training activations, using the subset of the extracted training activations to create one of the compressed histograms.

8. The computer-implemented method of claim 6, wherein using the extracted training activations to generate the compressed histograms includes:
sorting a respective training activation into a respective bin of the compressed histograms based on a numerical value of the respective training activation.

9. The computer-implemented method of claim 8, wherein a number of bins of the compressed histograms is determined based on a maximum of (i) an output of a Freedman Diaconis estimator, and (ii) an output of a Sturges estimator used to evaluate the training activations.

10. The computer-implemented method of claim 1, comprising:
causing the deep neural network to be retrained using the retained portions of the test data that are determined as being anomalous.

11. The computer-implemented method of claim 1, wherein the determination of anomalous data portions is implemented using non-parametric scan statistics.

12. The computer-implemented method of claim 9, wherein the non-parametric scan statistics include a higher criticism statistic.

13. The computer-implemented method of claim 1, wherein the p-values determined for the extracted activations include ranges of p-values for the respective extracted activations.

14. A computer program product comprising a computer readable storage medium having program instructions embodied therewith, the program instructions readable by a processor, executable by the processor, or readable and executable by the processor, to cause the processor to:
receive a new set of test data;
evaluate the test data using a pre-trained deep neural network;
extract activations from layers of the deep neural network in response to evaluating the test data;
use compressed histograms to determine p-values for the extracted activations;
evaluate the determined p-values; and
retain portions of the test data that are determined as being anomalous based at least in part on the evaluation of the p-values.

15. The computer program product of claim 14, wherein using compressed histograms to determine the p-values for the extracted activations includes, for each of the extracted activations:
determining a node of the deep neural network that a given extracted activation corresponds to;
comparing the given extracted activation to a compressed histogram correlated with the node that the given extracted activation corresponds to; and
computing a p-value for the given extracted activation.

16. The computer program product of claim 14, wherein the compressed histograms are node-specific.

17. The computer program product of claim 14, wherein retaining portions of the test data that are determined as being anomalous based at least in part on the evaluation of the p-values includes:
estimating a number of the extracted activations that are unexpected;
using the estimated number to determine whether at least a portion of the test data is anomalous; and
in response to determining that a portion of the test data is not anomalous, discarding (i) the portion of the test data, and (ii) the corresponding extracted activations.

18. A system, comprising:
a processor; and
logic executable by the processor to cause the processor to:
receive a new set of test data;
evaluate the test data using a pre-trained deep neural network;
extract activations from layers of the deep neural network in response to evaluating the test data;
use compressed histograms to determine p-values for the extracted activations;
evaluate the determined p-values; and
retain portions of the test data that are determined as being anomalous based at least in part on the evaluation of the p-values.

19. The system of claim 18, wherein retaining portions of the test data that are determined as being anomalous based at least in part on the evaluation of the p-values includes:
estimating a number of the extracted activations that are unexpected;
using the estimated number to determine whether at least a portion of the test data is anomalous;
in response to determining that a portion of the test data is not anomalous, discarding (i) the portion of the test data, and (ii) the corresponding extracted activations; and
in response to determining that another portion of the test data is anomalous, store (i) the anomalous portion of the test data, and (ii) the corresponding extracted activations.

20. The system of claim 18, wherein using compressed histograms to determine the p-values for the extracted activations includes, for each of the extracted activations:
determining a node of the deep neural network that a given extracted activation corresponds to;
comparing the given extracted activation to a compressed histogram correlated with the node that the given extracted activation corresponds to; and
computing a p-value for the given extracted activation.
